(19) United States
(12) Patent Application Publication
(10) Pub. No.: US 2025/0212188 A1
(43) Pub. Date: Jun. 26, 2025

(54) WIRELESS TERMINAL DEVICE

(71) Applicant: JVCKENWOOD Corporation, Yokohama-shi (JP)

(72) Inventor: Kazuomi TACHIGI, Yokohama shi (SA)

(21) Appl. No.: 19/077,473

(22) Filed: Mar. 12, 2025

Related U.S. Application Data
(63) Continuation of application No. PCT/JP2023/032425, filed on Sep. 5, 2023.

(30) Foreign Application Priority Data
Sep. 13, 2022 (JP) 2022-145451

(51) Int. Cl. H04W 72/0446; H04W 72/54; H04W 76/45

(52) U.S. Cl. CPC H04W 72/0446; H04W 72/54; H04W 76/45

(57) ABSTRACT

A demodulation unit receives a transmission signal of one time slot of timeslots, and demodulates an audio signal from the transmission signal. An audio output unit outputs audio of the demodulated audio signal. A signal detection unit sequentially switches a timeslot for receiving a transmission signal at the time of operating a transmission switch for switching from a reception state to a transmission state of a transmission signal, and detects an empty timeslot in which a transmission signal does not exist for each timeslot. A switching control unit suspends switching from the reception state to the transmission state when an empty timeslot does not exist in timeslots. A switching control unit returns a timeslot in which a transmission signal is received to a timeslot before an operation of the transmission switch.

### CROSS REFERENCE TO RELATED APPLICATIONS

This application is a continuation of PCT Application No. PCT/JP2023/032425, filed on Sep. 5, 2023, and claims the priority of Japanese Patent Application No. 2022-145451, filed on Sep. 13, 2022, the entire contents of both of which are incorporated herein by reference.

### BACKGROUND

The present disclosure relates to a wireless terminal device.

Patent Literature 1 (Japanese Unexamined Patent Application Publication No. 2010-109506) describes a wireless communication system in which a wireless terminal device communicates with another wireless terminal device via a repeater of an empty channel. In this system, each repeater shares information of the other repeater, and transmits a downlink signal including information of the other repeater to a wireless terminal device that sets the own device as a home repeater using its own channel.

When the other wireless terminal device is calling the own device, the wireless terminal device receives, from the home repeater, a downlink signal including information on the other repeater that has received the call of the own device. The wireless terminal device that has received the downlink signal including the information of the other repeater switches the channel for receiving the downlink signal and demodulating the audio signal from the channel of the home repeater to the channel of the other repeater.

### SUMMARY

As a digital communication system between wireless terminal devices, there is a digital mobile radio (DMR) digital communication system established by the European Telecommunications Standards Institute (ETSI). In this communication system, one channel is time-divided into two timeslots, and each timeslot is assigned to different communications.

The wireless terminal device of the DMR digital communication system receives one of the timeslots, demodulates the audio signal, and outputs the audio of the demodulated audio signal from a speaker. When the wireless terminal device communicates with another wireless terminal device instead of the wireless terminal device using the timeslot being received, the wireless terminal device confirms availability of the timeslot. When the other timeslot is empty instead of the timeslot being received, the wireless terminal device switches the timeslot to be received to an empty timeslot.

Even in the wireless terminal device of the DMR digital communication system, a procedure for switching a timeslot to be received is required as in the reception channel switching procedure in the wireless terminal device of Patent Literature 1.

It is desirable that a wireless terminal device using any one of a plurality of timeslots obtained by time-dividing one channel for communication suitably switches timeslots to be received and demodulated.

An aspect of one or more embodiments provides a wireless terminal device including: a demodulation unit configured to receive a transmission signal of one timeslot among a plurality of timeslots obtained by time-dividing one channel, and demodulate an audio signal from the transmission signal; an audio output unit configured to output audio of the audio signal demodulated by the demodulation unit; a transmission switch configured to be operated in a case where the transmission signal is switched from a reception state to a transmission state; a signal detection unit configured to, in a case where the transmission switch is operated, sequentially switch a timeslot in which the demodulation unit receives the transmission signal, and detect, for each timeslot, presence or absence of an empty timeslot in which the transmission signal does not exist; and a switching control unit configured to, in a case where the signal detection unit detects that the empty timeslot does not exist in the plurality of timeslots, suspend switching from the reception state to the transmission state and return the timeslot in which the demodulation unit receives the transmission signal to a timeslot before the operation of the transmission switch.

According to the wireless terminal device according to the embodiment, the wireless terminal device using one timeslot among a plurality of timeslots obtained by time-dividing one channel for communication can suitably switch timeslots for receiving and demodulating.

### BRIEF DESCRIPTION OF THE DRAWINGS

FIG. 1 is a diagram illustrating an example of a configuration of a wireless terminal device according to an embodiment.

FIG. 2 is a diagram illustrating an example of a case where communication of a DMR digital communication system is performed in a repeater mode by using a plurality of wireless terminal devices illustrated in FIG. 1.

FIG. 3 is a diagram illustrating each unit formed by a plurality of information processing circuits virtually constructed in a main controller unit illustrated in FIG. 1

FIG. 4 is a flowchart illustrating an example of a procedure of processing executed by a CPU of the main controller unit illustrated in FIG. 1.

FIG. 5 is a timing chart illustrating, as an example, a flow of operation of the wireless terminal device in a case where communication is performed between the terminals illustrated in FIG. 2.

### DETAILED DESCRIPTION

Hereinafter, a wireless terminal device according to an embodiment will be described with reference to the drawings. Throughout the drawings, the same or equivalent parts or components are denoted by the same reference numerals.

The following embodiment exemplifies a device and the like for embodying the technical idea of the present invention. The technical idea of the present invention does not specify the material, shape, structure, arrangement, and the like of each component as follows.

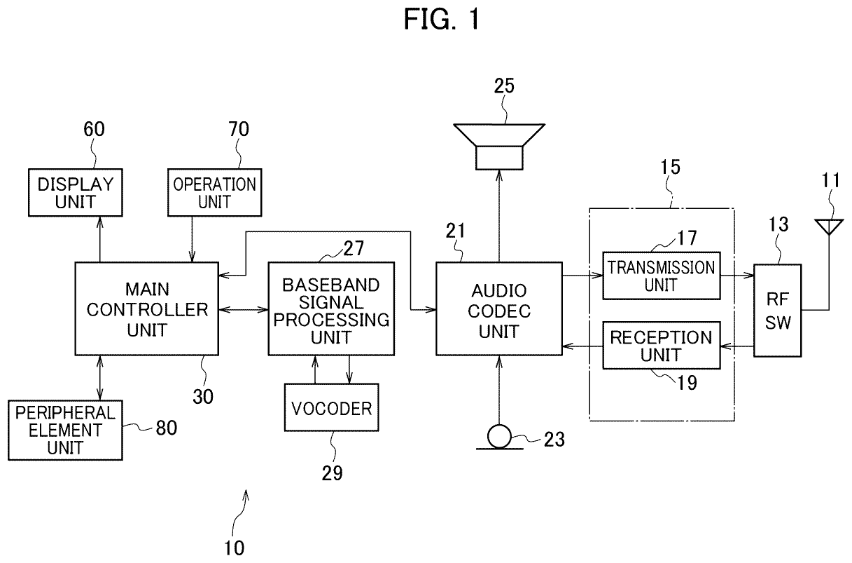

FIG. 1 is an explanatory diagram illustrating an example of a configuration of a wireless terminal device according to an embodiment. A wireless terminal device 10 of the present embodiment illustrated in FIG. 1 communicates with other wireless terminal devices (not illustrated) by the DMR digital communication system.

In the DMR digital communication system, one channel is time-divided into two timeslots, and each timeslot is allocated to different communications. In the DMR digital communication system, the wireless terminal device 10 of the transmission source calls a wireless terminal device of a communication partner using an empty timeslot.

The calling of the wireless terminal device includes calling by a group call and calling by an individual call. The group call is also referred to as a “group call”. In the group call, all the wireless terminal devices belonging to a group are simultaneously called as a communication partner. The individual call is also referred to as a two-way call. In the individual call, an individual wireless terminal device is called as a communication partner. The calling of an individual call with an individual wireless terminal device as a communication partner can be treated as a call with a higher priority than a call of a group call with a large number of wireless terminal devices belonging to a group as communication partners. The wireless terminal device 10 on the transmission side transmits a signal addressed to the wireless terminal device of the communication partner by using the empty timeslot and calls the wireless terminal device of the communication partner.

In a case where the own device is included in the destination of the signal of each timeslot, the wireless terminal device 10 on the reception side receives and demodulates the signal, and outputs the demodulated audio from the speaker. In a case where the own device is included in the destinations of the signals of both timeslots, for example, the wireless terminal device 10 receives and demodulates a call signal with higher priority, and outputs the demodulated audio from the speaker.

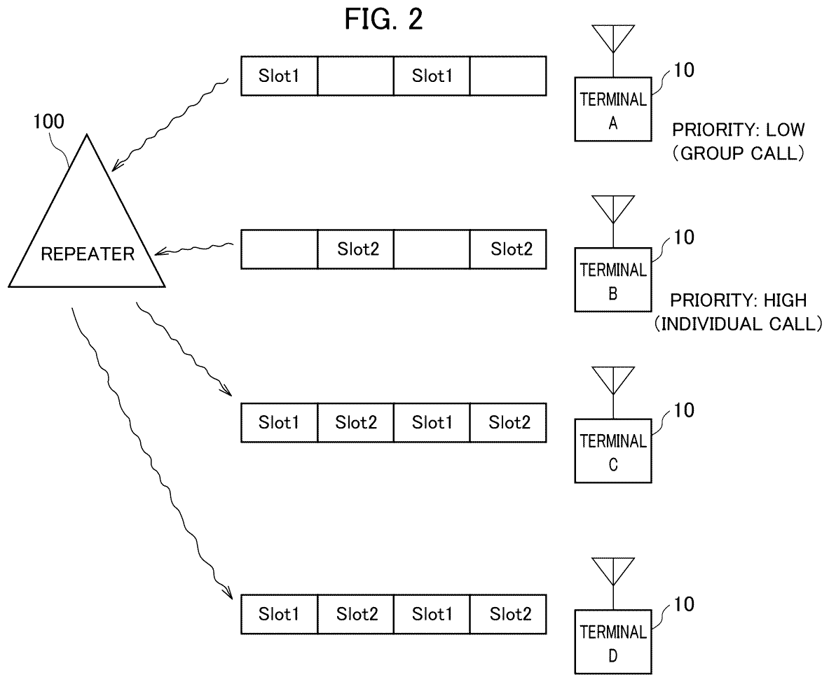

FIG. 2 illustrates an example of a case where communication is performed by the DMR digital communication system using a plurality of wireless terminal devices 10. This example illustrates a case where the four wireless terminal devices 10 of the terminals A to D communicate via a repeater 100 which is a repeater in a repeater mode in the channel of the same frequency.

First, it is assumed that the wireless terminal device 10 of the terminal A calls one or a plurality of wireless terminal devices 10 other than the terminal B as a communication partner in a state where both timeslots of channels used by the terminals A to D for communication are empty. In this case, the wireless terminal device 10 of the terminal A transmits a signal to the communication partner using one empty timeslot of the two timeslots. FIG. 2 illustrates a case where a timeslot 1 is used.

It is assumed that the wireless terminal device 10 of the terminal B calls one or a plurality of wireless terminal devices 10 other than the terminal A as a communication partner in a state where the terminal A starts a call using one timeslot. In this case, the wireless terminal device 10 of the terminal B transmits a signal to the communication partner using the remaining one empty timeslot. FIG. 2 illustrates a case where a timeslot 2 is used.

In a case where signals of the timeslots 1 and 2 include the own devices as destinations, the wireless terminal devices 10 of the terminal C and the terminal D receive and demodulate the signals including the own devices as destinations from the timeslots 1 and 2, and output the demodulated audio from the speaker. In a case where signals of the timeslots 1 and 2 both include the own devices as destinations, the wireless terminal devices 10 of the terminal C and the terminal D receive and demodulate a signal of a call having a high priority from one of the timeslots 1 and 2, and output the demodulated audio of the call having the high priority from the speaker.

In a case where none of signals of the timeslots 1 and 2 includes the own devices as destinations, the wireless terminal devices 10 of the terminal C and the terminal D do not receive or demodulate either of the signals of the timeslots 1 and 2.

In this case, no audio is output from the speaker of the wireless terminal devices 10.

As illustrated in FIG. 1, the wireless terminal device 10 includes an antenna 11, a radio frequency switch (RFSW) 13 and a transmission/reception unit 15. The transmission/reception unit 15 includes a transmission unit 17 and a reception unit 19. One of the transmission unit 17 and the reception unit 19 is selectively connected to the antenna 11 via the high frequency switch 13.

The wireless terminal device 10 further includes an audio codec unit 21, a microphone 23, a speaker 25, a baseband signal processing unit 27, a vocoder 29, and a main controller unit 30.

A signal received from the air by the reception unit 19 through the antenna 11 is encoded into a digital signal by the audio codec unit 21. The digital signal is a signal obtained by modulating a carrier wave with a baseband signal. In the case of the wireless terminal device 10, the baseband signal is an audio signal. In a case where the digital signal includes the own device as a destination, the baseband signal processing unit 27 demodulates the baseband signal from the digital signal.

The main controller unit 30 extracts an audio signal from the demodulated baseband signal. The extracted audio signal is subjected to audio processing in the vocoder 29. The audio signal after the audio processing is decoded into an analog signal by the audio codec unit 21 and output from the speaker 25.

The audio collected by the microphone 23 is encoded into a digital signal by the audio codec unit 21, and compressed and encoded by the vocoder 29. The main controller unit 30 generates a baseband signal from the encoded digital signal. The generated baseband signal is used for modulation of a carrier wave in the baseband signal processing unit 27. The digital signal modulated by the baseband signal in which destination information is added is decoded into an analog signal by the audio codec unit 21, and transmitted from the transmission unit 17 to the air through the antenna 11.

The wireless terminal device 10 further includes a display unit 60, an operation unit 70, and a peripheral element unit 80.

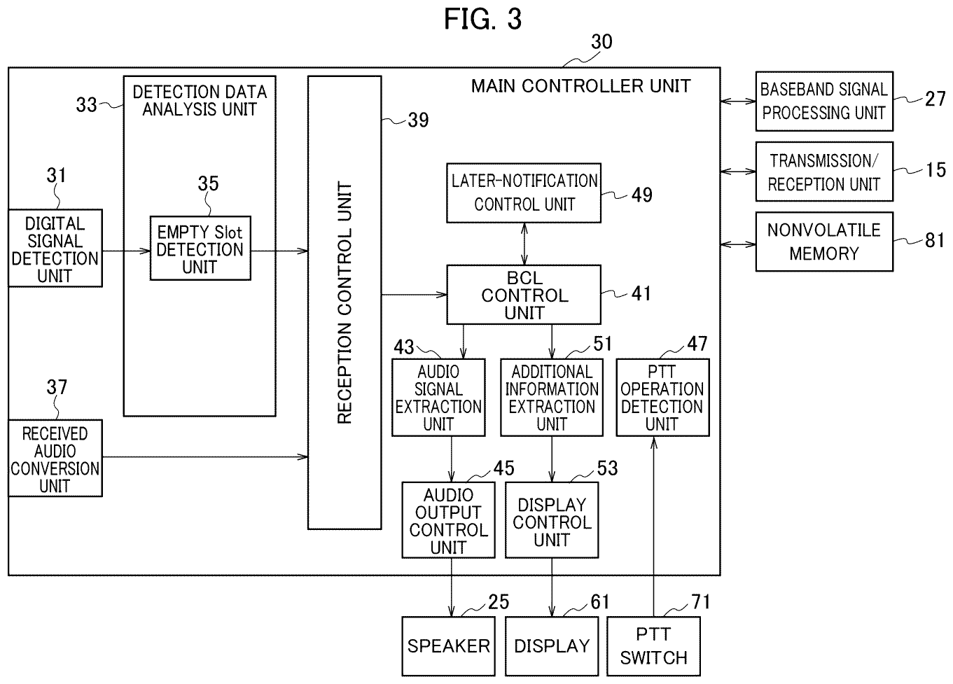

The display unit 60 includes a display 61 illustrated in FIG. 3. The display 61 displays a state of the wireless terminal device 10 and the like.

The operation unit 70 illustrated in FIG. 1 includes a push to a talk (PTT) switch 71 illustrated in FIG. 3. The PTT switch 71 is pressed by a user when the wireless terminal device 10 calls the wireless terminal device of the communication partner and transmits a signal to the communication partner. The PTT switch 71 is in a pressed state by a pressing operation, and is in a released state by release of the pressing operation.

The peripheral element unit 80 of FIG. 1 includes a nonvolatile memory 81 illustrated in FIG. 3. In the nonvolatile memory 81, for example, a list of the wireless terminal devices 10 of the communication partners of the individual call and the group call can be stored as a partner station list.

The main controller unit 30 in FIG. 1 controls the operation of each unit from the antenna 11 to the vocoder 29 described above so as to transmit and receive signals relative to the other wireless terminal devices 10 by the DMR digital communication system.

The main controller unit 30 includes a general-purpose microcontroller (not illustrated). The microcontroller includes a central processing unit (CPU) and a memory (not illustrated). The memory includes a read only memory (ROM) and a random access memory (RAM).

The microcontroller can virtually form a plurality of information processing circuits by causing the CPU to execute a program stored in the memory. The plurality of information processing circuits can be used to form each of units 31 to 53 of the main controller unit 30 illustrated in FIG. 3 described later.

In the present embodiment, an example in which a plurality of information processing circuits formed in the microcontroller of the main controller unit 30 are realized by software will be described. Of course, the information processing circuit can be formed by preparing dedicated hardware for executing each information processing described below. In addition, a plurality of information processing circuits may be formed by individual hardware. Dedicated hardware includes a device such as application specific-integrated circuits (ASIC), a conventional circuit component or the like arranged to perform the functions described below of each of units 31 to 53 of the main controller unit 30.

The plurality of information processing circuits of the main controller unit 30 form a digital signal detection unit 31, a detection data analysis unit 33 including an empty slot detection unit 35, a received audio conversion unit 37, and a reception control unit 39 illustrated in FIG. 3. The plurality of information processing circuits further includes a busy channel lockout (BCL) control unit 41, an audio signal extraction unit 43, an audio output control unit 45, a PTT operation detection unit 47, a later-notification control unit 49, an additional information extraction unit 51, and a display control unit 53.

A digital signal of a channel used by the wireless terminal device 10 is encoded by the audio codec unit 21 and input to the digital signal detection unit 31. The detection data analysis unit 33 analyzes the digital signal input to the digital signal detection unit 31. The analysis content of the detection data analysis unit 33 includes detection of destinations of signals present on two timeslots of a channel used by the wireless terminal device 10.

The empty slot detection unit 35 of the detection data analysis unit 33 detects whether or not there is an empty timeslot in the channel used by the wireless terminal device 10. The analysis result of the detection data analysis unit 33 is output to the BCL control unit 41 by the reception control unit 39. The analysis result of the detection data analysis unit 33 includes the detection result of the empty slot detection unit 35.

A baseband signal demodulated by the baseband signal processing unit 27 from a signal including the own device in a timeslot as a destination is input to the received audio conversion unit 37. In a case where the signals on the two timeslots both include the own device as a destination, the baseband signal demodulated by the baseband signal processing unit 27 from the signal on each timeslot is input to the received audio conversion unit 37 at the timing of each timeslot.

The BCL control unit 41 can execute processing related to the busy channel lockout function mounted on the wireless terminal device 10. The busy channel lockout function is a function of prohibiting signal transmission and locking a call in a situation where a call cannot be started in a case where the user performs transmission by pressing operation of the PTT switch 71. For example, in a case where the user tries to call the communication partner who is on another call, the call is locked by the busy channel lockout function in a case where both of the two timeslots of the channel are being used on the other call.

With respect to the signal received by the reception unit 19, the BCL control unit 41 outputs, to the audio signal extraction unit 43, a baseband signal demodulated from a signal including the own device as a destination, which is input from the received audio conversion unit 37 by the reception control unit 39. In a case where the baseband signal demodulated from the signal on each timeslot is input to the received audio conversion unit 37 at the timing of each timeslot, the BCL control unit 41 outputs the baseband signal demodulated from the signal of the call with high priority to the audio signal extraction unit 43.

The audio signal extraction unit 43 extracts an audio signal from the baseband signal, allows the audio output control unit 45 to decode the extracted audio signal into an analog signal by the audio codec unit 21, and allows the speaker 25 to output the analog signal.

The BCL control unit 41 refers to the analysis result of the detection data analysis unit 33 input from the reception control unit 39 in order to determine whether it is necessary to lock the call of the wireless terminal device 10 by the busy channel lockout function.

The BCL control unit 41 determines that the signal cannot be transmitted in a case where the analysis result referred to when the PTT operation detection unit 47 detects the pressing operation of the PTT switch 71 includes the detection result of the empty slot detection unit 35 that an empty timeslot does not exist in the channel. Also in a case where the analysis result referred to at the time of detecting the pressing operation of the PTT switch 71 includes a content that the other communication partner designated before the operation of the PTT switch 71 is on a call on the timeslot being used, the BCL control unit 41 determines that the signal cannot be transmitted.

In a case where the BCL control unit 41 determines that the signal cannot be transmitted, the call of the wireless terminal device 10 associated with the pressing operation of the PTT switch 71 detected by the PTT operation detection unit 47 is locked by the busy channel lockout function. In a case where the call is locked, the BCL control unit 41 requests the later-notification control unit 49 to notify the user of the wireless terminal device 10 that is the own device when the timeslot becomes empty.

In a case where the BCL control unit 41 determines that a signal cannot be transmitted, the additional information extraction unit 51 extracts, from the analysis result of the detection data analysis unit 33, additional information used to display that a signal cannot be transmitted on the display 61. The display control unit 53 allows the display 61 to display the determination that the signal cannot be transmitted by using the additional information extracted by additional information extraction unit 51.

In a case where the analysis result of the detection data analysis unit 33 referred to at the time of detecting the operation of the PTT switch 71 includes the detection result of the empty slot detection unit 35 that an empty timeslot exists in the channel, the BCL control unit 41 starts signal transmission by the empty timeslot. After the transmission is started, a digital signal modulated by a baseband signal including an audio collected by the microphone 23 of FIG. 1 is transmitted from the transmission unit 17 of the transmission/reception unit 15 to the air through the antenna 11.

In a case where the BCL control unit 41 refers to the detection result of the empty slot detection unit 35 that there is an empty timeslot when the PTT operation detection unit 47 does not detect the operation of the PTT switch 71, the BCL control unit 41 makes an inquiry to the later-notification control unit 49. The later-notification control unit 49 replies to the BCL control unit 41 whether or not notification indicating that an empty timeslot occurs is requested.

In a case where the response of the later-notification control unit 49 indicates that notification is requested, the BCL control unit 41 allows the audio signal extraction unit 43 and the audio output control unit 45 to output a beep sound from the speaker 25. The beep sound is a warning sound for notifying the user that the timeslot becomes empty. The BCL control unit 41 may allow the display 61 to display that the timeslot becomes empty.

Meanwhile, in the wireless terminal device 10, in a case where the PTT switch 71 is pressed, the BCL control unit 41 determines whether or not to lock the call by the busy channel lockout function. At the time of this determination, the BCL control unit 41 switches the digital signal for demodulating the baseband signal by the baseband signal processing unit 27, and individually confirms whether or not the two timeslots are empty.

The audio codec unit 21, the baseband signal processing unit 27, and the vocoder 29 of the wireless terminal device 10 are shared for reception and demodulation of the signal of each timeslot. At the time of determination by the busy channel lockout function, the audio that can be output from the speaker 25 is limited to the audio demodulated from the signal of the timeslot to be confirmed as to whether the timeslot is empty out of the two timeslots.

As a result of confirmation of empty of timeslots, in a case where an empty timeslot does not exist in either timeslot, the audio that can be output by the speaker 25 is an audio demodulated from the signal of the timeslot for which the empty of timeslot is confirmed later among the two timeslots.

For example, when the PTT switch 71 is pressed by the user in a state where the wireless terminal device 10 demodulates a signal including the own device as a destination and outputs the demodulated audio from the speaker 25, the BCL control unit 41 first confirms empty of a timeslot of a signal in which an audio is being output from the speaker 25. Since this timeslot is being used for transmission of a signal including the own device as a destination, the BCL control unit 41 switches the target to another timeslot and performs empty confirmation. In a case where the other timeslot is also being used, for example, in transmission of a signal that does not include the own device as a destination, the call is locked by the busy channel lockout function.

Since the empty of the timeslot is not confirmed by the BCL control unit 41 after the call is locked, the signal for demodulating the audio that can be output from the speaker 25 is held in a signal that does not include the own device as the destination in the timeslot for which the empty is confirmed later.

In this case, if the detection data analysis unit 33 detects a signal including the own device as a destination, and the audio signal extraction unit 43 extracts an audio signal by demodulating the detected signal, the audio of the signal including the own device as a destination can be output from the speaker 25 again. However, while the processing is performed, at least the output from the speaker 25 of the audio of the signal including the own device as the destination is interrupted. This interruption becomes a factor that makes it difficult to grasp the content of the call of the signal including the own device as the destination.

Under the above circumstances, in performing communication by the DMR digital communication system, the wireless terminal device 10 preferably switches a timeslot for receiving and demodulating a signal when detecting an empty timeslot used for a call with another wireless terminal device 10.

In the wireless terminal device 10 of the present embodiment, in a case where an empty timeslot is detected based on the pressing operation of the PTT switch 71 by the user, the timeslot to receive and demodulate a signal is suitably switched.

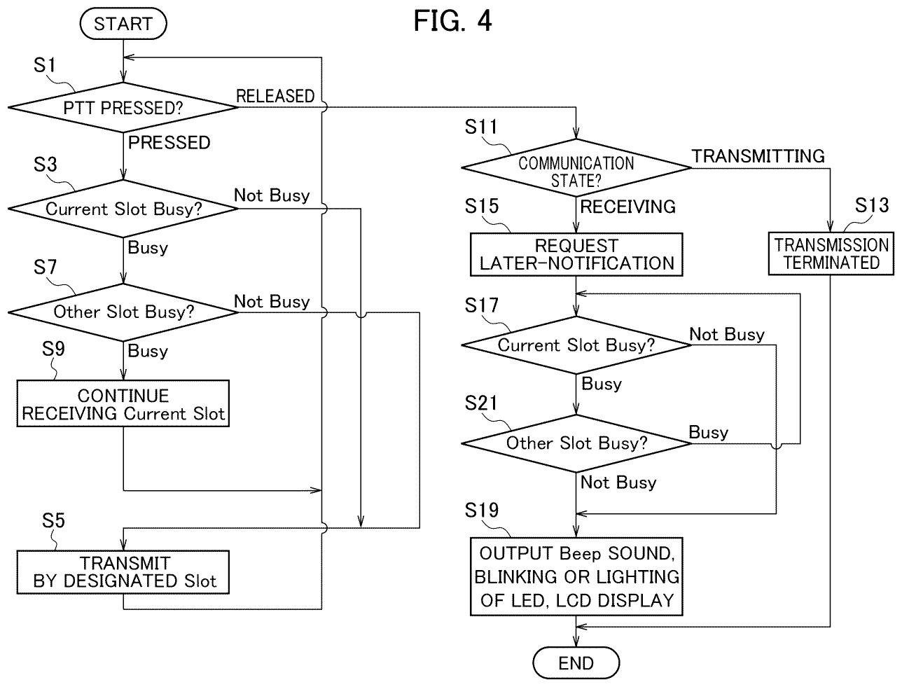

In order to suitably switch timeslots, in the wireless terminal device 10 of the present embodiment, the microcontroller of the main controller unit 30 executes processing of a procedure illustrated by an example in the flowchart of FIG. 4.

The microcontroller of main controller unit 30 confirms whether the PTT switch 71 is in a pressed state (step S1). In a case where the PTT switch 71 is not in the pressed state but in the released state (step S1: NO), the processing proceeds to step S11 described later. When the PTT switch 71 is in the pressed state (step S1: YES), the microcontroller confirms whether the current slot is used for communication and is in use (busy) (step S3).

The current slot indicates one of two timeslots currently designated by the main controller unit 30 as a timeslot of a signal reception source. The speaker 25 outputs the audio of the audio signal extracted from the baseband signal obtained by demodulating the signal of the current slot.

In a case where the current slot is not busy (step S3: Not Busy), the microcontroller transmits a signal of call for calling the communication partner in one timeslot currently designated by the main controller unit 30 (step S5). After the transmission of the signal of call, the processing returns to step S1.

In a case where the current slot is busy (step S3: Busy), the microcontroller changes the timeslot designated by the main controller unit 30 as the timeslot of the signal reception source from one timeslot to the other timeslot. Then, the microcontroller confirms whether or not the other slot which is the other time slot is busy (step S7).

In a case where the other slot is not busy (step S7: Not Busy), the microcontroller transmits a signal of call for calling the communication partner in the other timeslot currently designated by the main controller unit 30 (step S5). After the transmission of the signal of call, the processing returns to step S1.

In a case where the other slot is busy (step S7: Busy), the microcontroller changes the timeslot designated by the main controller unit 30 as the timeslot of the signal reception source from the other timeslot to one timeslot. After the timeslot designated by the main controller unit 30 is changed, the processing returns to step S1.

In a case where the PTT switch 71 is not in the pressed state but in the released state in step S1 (step S1: NO), the microcontroller determines in step S11 that the PTT switch 71 has changed from the pressed state to the released state. Based on this determination, the microcontroller confirms the communication state of the wireless terminal device 10 before the change.

In the pressed state of the PTT switch 71 before the change, in a case where the communication state of the wireless terminal device 10 is in the transmission state of a signal of call (step S11: transmitting), the microcontroller performs transmission completion processing for terminating the transmission of the signal of call (step S13), and then terminates the series of processing.

In the pressed state of the PTT switch 71 before the change, in a case where the communication state of the wireless terminal device 10 is in the reception state of the signal of call (step S11: receiving), the microcontroller requests the later-notification control unit 49 to notify in a case where the timeslot becomes empty in the future (step S15).

The microcontroller confirms whether or not the current slot is busy (step S17). In a case where the current slot is busy (step S17: Busy), the microcontroller notifies that an empty timeslot has occurred (step S19). After the notification of the occurrence of empty, a series of processing is terminated.

The notification in step S19 may be, for example, to allow the speaker 25 to output a beep sound, which is a warning sound indicating that an empty timeslot has occurred. In the notification in step S19, in addition to the output of the beep sound, for example, an indication that an empty timeslot has occurred may be displayed on the display 61. The indication displayed on the display 61 is, for example, blinking or lighting of a light emitting diode (LED), or an indication of texts or the like on a liquid crystal display (LCD).

In a case where the current slot is not busy (step S17: Not Busy), the microcontroller confirms whether or not the other slot is busy (step S21). In a case where the other slot is busy (step S21: Busy), the processing returns to step S17.

In a case where the other slot is not busy (step S21: Not Busy), the microcontroller notifies that an empty timeslot has occurred (step S19). After the notification of the occurrence of empty, a series of processing is terminated.

By the microcontroller of the main controller unit 30 executing the processing of the above procedure, the wireless terminal device 10 of the present embodiment may be provided with a demodulation unit, an audio output unit, a transmission switch, a signal detection unit, a switching control unit, a suspension control unit, and a notification unit.

Among them, the demodulation unit receives a transmission signal of one timeslot among a plurality of timeslots obtained by time-dividing one channel, and demodulates an audio signal from the transmission signal. The demodulation unit can be realized by using the audio codec unit 21, the baseband signal processing unit 27, the vocoder 29, and the main controller unit 30.

The audio output unit outputs audio of the audio signal demodulated by the demodulation unit. The audio output unit can be realized by using the speaker 25 and the main controller unit 30.

The transmission switch is operated when the reception state of the transmission signal is switched to the transmission state. The transmission switch may be the PTT switch 71.

In a case where the transmission switch is operated, the signal detection unit sequentially switches timeslots in which the demodulation unit receives the transmission signal, and detects the presence or absence of an empty timeslot in which the transmission signal does not exist for each timeslot. The signal detection unit can be realized by using the main controller unit 30. The microcontroller of the main controller unit 30 can realize the operation of the signal detection unit by performing the processing from step S1 to step S3 and step S7 in FIG. 4.

The switching control unit suspends switching from the reception state to the transmission state in a case where the signal detection unit detects that an empty timeslot does not exist in the plurality of timeslots. In addition, the switching control unit returns the timeslot in which the demodulation unit receives the transmission signal to the timeslot before the operation of the transmission switch.

Here, “return” refers to returning the timeslot in which the demodulation unit receives the transmission signal to the state before the operation of the transmission switch. More specifically, “return” refers to returning to the timeslot in which the demodulation unit receives the transmission signal by the switching control unit switching the timeslot switched by the detection of the empty timeslot to the timeslot before the operation of the transmission switch. Here, “return” is performed so that the demodulation unit continues to receive the transmission signal even in a case where the signal detection unit detects that an empty timeslot does not exist in the plurality of timeslots and suspends the switching from the reception state to the transmission state. The switching control unit can be realized by using the main controller unit 30. The microcontroller of the main controller unit 30 can realize the operation of the switching control unit by performing the processing from step S7 to step S9 in FIG. 4.

In addition, the switching control unit may continue to suspend the switching from the reception state to the transmission state while the transmission switch is operated. The switching control unit in this case can also be realized by using the main controller unit 30. By performing the processing of returning from step S9 to step S1 in FIG. 4, the microcontroller of the main controller unit 30 can realize the operation of the switching control unit that continues the suspension of the switching from the reception state to the transmission state while the transmission switch is operated.

The suspension control unit controls the signal detection unit to intermittently execute detection of an empty timeslot to be executed for each timeslot in a case where the operation of the transmission switch is canceled while the switching from the reception state to the transmission state by the switching control unit is suspended. The suspension control unit can be realized by using the main controller unit 30. The microcontroller of the main controller unit 30 can realize the operation of the suspension control unit by performing the processing from the release in step S1 returned from step S9 in FIG. 4 to step S17 and step S19 through the reception in step S11.

The notification unit notifies the user of the own device of occurrence of an empty timeslot in a case where the signal detection unit detects that the empty timeslot exists in a plurality of timeslots in detection of the empty timeslot intermittently executed by the signal detection unit. The notification unit can be realized by using at least one of the speaker 25 and the display 61 and the main controller unit 30. The microcontroller of the main controller unit 30 can realize the operation of the notification unit by performing the process from step S15 to step S17 or step S19 in FIG. 4 and proceeding to step S21.

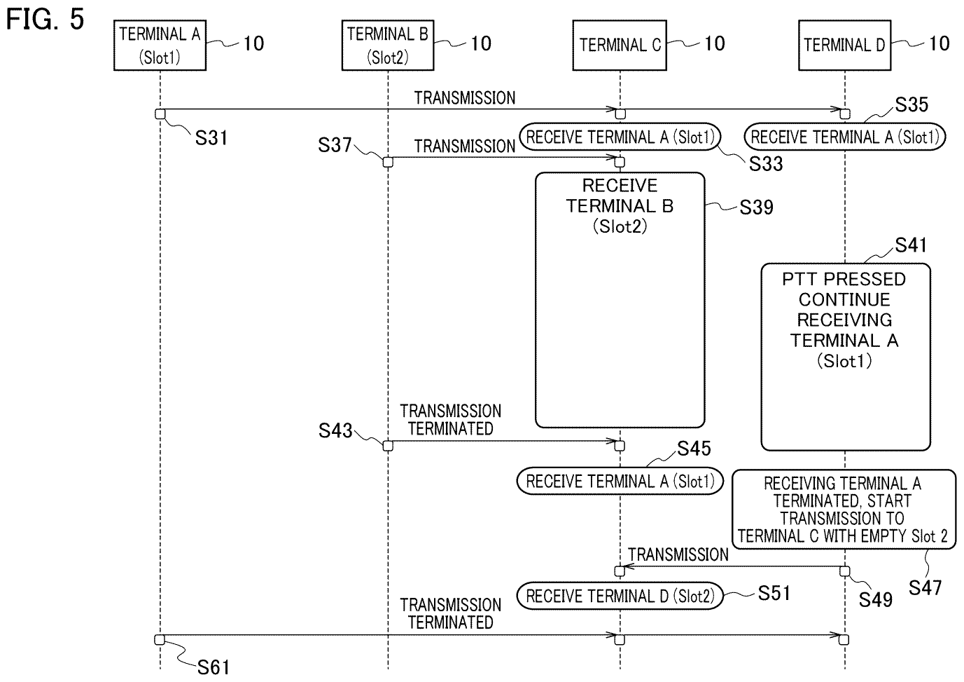

Next, an operation occurring in the wireless terminal device 10 in communication using a plurality of wireless terminal devices 10 of the present embodiment will be described with reference to a time chart of FIG. 5. The time chart of FIG. 5 illustrates, as an example, a flow of operation of the wireless terminal device 10 in a case where communication is performed between the terminals A to D of FIG. 2.

First, the wireless terminal device 10 of the terminal A calls the wireless terminal devices 10 of the terminal C and the terminal D belonging to the group by the group call using the empty timeslot 1 (step S31). The wireless terminal devices 10 of the terminal C and the terminal D receive a signal including the own devices as destinations from the timeslot 1, and output the audio of the terminal A demodulated from the received signal from the speaker 25 (steps S33 and S35).

After the start of the group call by the terminal A, the wireless terminal device 10 of the terminal B calls the terminal C by the individual call using the empty timeslot 2 (step S37). The wireless terminal device 10 of the terminal C receives, from the timeslot 2, a signal from the individual call from the terminal B, which includes the own device as a destination and has a higher priority than the signal from the terminal A, and outputs, from the speaker 25, the audio of the terminal B demodulated from the received signal (step S39).

During a call by the terminal A and the terminal B, in the wireless terminal device 10 of the terminal D, in order to start a call calling the other terminals except the terminal A and the terminal B during the call, the PTT switch 71 is in a pressed state by the user's pressing operation (step S41). In this case, the wireless terminal device 10 of the terminal D detects an empty timeslot in the order of the timeslot 1 receiving the original signal obtained by demodulating the audio of the terminal A output from the speaker 25 and the other timeslot 2.

Since both the timeslots 1 and 2 are being used in a call by the terminal A and the terminal B, the wireless terminal device 10 of the terminal D locks the call by the busy channel lockout function. After the call is locked, the wireless terminal device 10 of the terminal D returns the timeslot of the signal reception source from the timeslot 2 in which the last empty timeslot is detected to the timeslot 1, and continues the state of outputting the audio of the terminal A from the speaker 25 (step S41).

Here, “return” refers to returning the timeslot in which the demodulation unit receives the transmission signal to the state before the operation of the transmission switch. More specifically, “return” refers to returning to the state before the detection of the empty timeslot is started by the wireless terminal device 10 of the terminal D switching the timeslot of the signal reception source from the timeslot 2 in which the empty timeslot is detected last to the timeslot 1 after the call is locked. Note that detection of an empty timeslot is performed in a case where the PTT switch 71 becomes a pressed state by a pressing operation. The return here is performed in order that the wireless terminal device 10 of the terminal D receives a signal including the own device as a destination from the timeslot 1 and starts a call calling the other terminals except the terminal A and the terminal B being on the call.

In the wireless terminal device 10 of the terminal D, it is assumed that the PTT switch 71 is switched from the pressed state to the released state by the release of the pressing operation after the call is locked. By this switching, the wireless terminal device 10 of the terminal D requests the later-notification control unit 49 to notify that the timeslots 1 and 2 become empty in the future.

After the PTT switch 71 of the wireless terminal device 10 of the terminal D is switched to the released state, in a case where the terminal B terminates the individual call with the terminal C as the communication partner (step S43), the wireless terminal device 10 of the terminal C switches the timeslot for receiving the signal to the timeslot 1. By this switching, the wireless terminal device 10 of the terminal C switches the audio output from the speaker 25 from the audio of the terminal B to the audio of the terminal A (step S45).

In a case where the terminal B terminates the individual call with the terminal C as the communication partner (step S43), the wireless terminal device 10 of the terminal D notifies occurrence of empty of the timeslot 2. In a case where the PTT switch 71 of the wireless terminal device 10 of the terminal D is switched to the pressed state again with this notification as a trigger, the wireless terminal device 10 of the terminal D starts transmission of the call using the timeslot 2 in which the reception of the signal of the terminal A is terminated (step S47). This call can be a call calling the other terminals except for terminal B being on the call.

In a case where the wireless terminal device 10 of the terminal D starts, for example, an individual call with the terminal C as a communication partner (step S49), the wireless terminal device 10 of the terminal D terminates the reception and demodulation of the signal of the time slot 1 and terminates the output of the audio of the terminal A from the speaker 25.

In a case where the wireless terminal device 10 of the terminal D starts an individual call with the terminal C as a communication partner, the wireless terminal device 10 of the terminal C detects a signal including the own device as a destination in each of the timeslots 1 and 2. The wireless terminal device 10 of the terminal C receives a signal by an individual call from the terminal D, which has a higher priority than the signal from the terminal A, from the timeslot 2. The wireless terminal device 10 of the terminal C outputs the audio of the terminal D demodulated from the signal received from the timeslot 2 from the speaker 25 (step S51).

Note that the wireless terminal device 10 of the terminal D that has started the individual call with the terminal C as the communication partner terminates receiving and demodulating the signal of the timeslot 1 and outputs the audio of the terminal A from the speaker 25. After the wireless terminal device 10 of the terminal D starts the individual call with the terminal C as the communication partner, in a case where the terminal A terminates the group call with the terminal C and the terminal D as the communication partners (step S61), the transmission of the signal from the terminal A using the timeslot 1 terminates. Even in a case where the group call the by terminal A terminates, the transmission/reception states of the wireless terminal devices 10 of the terminal C and the terminal D do not change.

In the present embodiment, in a case where the pressing operation is performed on the PTT switch 71 in a state where the audio of the call of the signal including the own device as the destination is output from the speaker 25, in a case where an empty timeslot does not exist, the audio of the same call is continuously output from the speaker 25. Therefore, in a case where an empty timeslot does not exist at the time of the pressing operation of the PTT switch 71, the period during which the audio output from the speaker 25 before the pressing operation of the PTT switch 71 is temporarily not output can be shortened as much as possible. Therefore, it is possible to suppress the difficulty in grasping the content of the call of the signal including the own device as the destination.

In addition, in the present embodiment, even after the pressing operation of the PTT switch 71 is released in a state where an empty timeslot does not exist, detection of the empty timeslot is continued. In a case where an empty timeslot is detected during continuation, it is possible to notify the user that an empty timeslot has occurred by notification performed on at least one of the speaker 25 and the display 61.

Note that the suspension control unit provided in the wireless terminal device 10 may control the signal detection unit to intermittently detect an empty timeslot performed for each timeslot even in a case where the operation of the transmission switch is not canceled while the switching from the reception state to the transmission state by the switching control unit is suspended. The suspension control unit in this case can also be realized by using the main controller unit 30. The microcontroller of the main controller unit 30 can realize the operation of the suspension control unit in this case by performing the process of proceeding to step S11 without returning to step S1 after step S9 in FIG. 4.

In addition, the switching control unit may switch the own device to the transmission state in a case where it is detected that an empty timeslot exists in a plurality of timeslots in the detection that the suspension control unit controls the signal detection unit to intermittently execute while the switching to the transmission state is suspended. The switching control unit in this case can be realized by using the main controller unit 30. The microcontroller of the main controller unit 30 can realize the operation of the switching control unit in this case by executing the processing performed at the time of the operation of step S47 in FIG. 5.

Although the embodiment of the present invention has been described above, the embodiment can be modified or modified based on the above disclosure. All the components of the above embodiments and all the features described in the claims may be individually extracted and combined as long as they do not contradict each other.

What is claimed is:

1. A wireless terminal device comprising:
a demodulation unit configured to receive a transmission signal of one timeslot among a plurality of timeslots obtained by time-dividing one channel, and demodulate an audio signal from the transmission signal;
an audio output unit configured to output audio of the audio signal demodulated by the demodulation unit;
a transmission switch configured to be operated in a case where the transmission signal is switched from a reception state to a transmission state;
a signal detection unit configured to, in a case where the transmission switch is operated, sequentially switch a timeslot in which the demodulation unit receives the transmission signal, and detect, for each timeslot, presence or absence of an empty timeslot in which the transmission signal does not exist; and
a switching control unit configured to, in a case where the signal detection unit detects that the empty timeslot does not exist in the plurality of timeslots, suspend switching from the reception state to the transmission state and return the timeslot in which the demodulation unit receives the transmission signal to a timeslot before the operation of the transmission switch.

2. The wireless terminal device according to claim 1, further comprising: a suspension control unit configured to control the signal detection unit to intermittently execute the detection while the switching by the switching control unit is suspended; and a notification unit configured to notify a user of the own device of occurrence of the empty timeslot in a case where the signal detection unit detects that the empty timeslot exists in the plurality of timeslots in the detection intermittently executed.

3. The wireless terminal device according to claim 2, wherein the suspension control unit is configured to control the signal detection unit to intermittently execute the detection in a case where an operation of the transmission switch is canceled while the switching by the switching control unit is suspended.

4. The wireless terminal device according to claim 1, wherein the switching control unit is configured to continue suspension of the switching while the transmission switch is operated.

5. The wireless terminal device according to claim 1, further comprising a suspension control unit configured to control the signal detection unit to intermittently execute the detection while the switching by the switching control unit is suspended, wherein the switching control unit is configured to switch the own device from the reception state to a transmission state in a case where the signal detection unit detects that the empty timeslot exists in the plurality of timeslots in the detection intermittently executed.
